(19) United States
(12) Patent Application Publication
(10) Pub. No.: US 2015/0100359 A1
(43) Pub. Date: Apr. 9, 2015

(54) System and Method of Routing Customer Care Cases for Electronic Devices

(71) Applicant: CrowdCare Corporation, Richmond Hill (CA)

(72) Inventors: Jeffrey Brunet, Aurora (CA); Ian Collins, Markham (CA); Karen Chan, Richmond Hill (CA); Yousuf Chowdhary, Maple (CA)

(21) Appl. No.: 14/507,017

(22) Filed: Oct. 6, 2014

Related U.S. Application Data
(60) Provisional application No. 61/961,133, filed on Oct. 7, 2013.

(51) Int. Cl. G06Q 10/06; G06Q 30/00

(52) U.S. Cl. CPC G06Q 10/06311; G06Q 30/01
USPC 705/7.13

(57) ABSTRACT

A computer-implemented method is provided for providing customer care to a user of an electronic device. After a device profile of the electronic device is received, together with any text added by the user in a query, a customer care case is created with the received parameters from the device profile and the added text from the user. This customer care case is then automatically routed to an appropriate resource or customer care agent channel based on analysis of the parameters and the added text. A separate but related method also relates to the database of expertise and availability parameters that is maintained for a plurality of customer care agents. The database is used for the aforementioned analysis and routing.

### CROSS-REFERENCE TO RELATED APPLICATIONS

This application claims the benefit of U.S. Provisional Patent Application No. 61/961,133, filed Oct. 7, 2013 and entitled “System and Method of Routing Customer Care Cases for Electronic Devices”, which is incorporated herein by reference in its entirety.

### FIELD OF INVENTION

The invention in general relates to customer care systems for electronic devices and in particular relates to electronic communication devices for example Smartphones, tablets, TVs, entertainment systems, vehicles, navigation systems etc.

### BACKGROUND OF THE INVENTION

The current method of gathering and obtaining device information required for diagnostics is manual and therefore complex, time-consuming and prone to human errors. In the course of a customer care session for a device, a CSR (Customer Service Representative) must undertake the extensive and time-consuming task of asking the user complex questions pertaining to their wireless devices for problem diagnosis. This requires CSRs to be experts on many types of devices and their applications, and also requires users to spend increased time on the telephone to receive support for their applications. This situation is only getting worse with the passage of time as devices become more powerful and capable of handling more sophisticated tasks. The result is increased support costs, increased call handling times, complex diagnostic processes and overall frustration.

One prior art method to overcome the above issues is self-care, whereby information is provided to users and they can use the information to resolve some of the basic issues themselves, thus helping reduce some of the costs. Such prior art methods still lack automation and the user is required to sift through massive amounts of data manually to get to the relevant information. While such central knowledge-bases offer limited help for example static lists of “frequently asked questions” that can become outdated quickly as well as a single point of failure.

Typically if issues cannot be resolved by self-care, such issues are escalated to the customer care departments of the service or device providers. In order to obtain assistance, the customer is required to tell the customer care agent sufficient details about the customer's device e.g. device make, model, version and the issue the customer may be encountering. Using this information that is provided by the customer orally to the customer care agent, the customer call may be routed to the most appropriate resource, i.e. a person in the customer care team who is best suited to tackle this issue. This verbal conveyance of information is prone to error and leads to considerably longer call times, frustration, and overall inefficiency.

Additionally many customers are not keen to make phone calls to customer care departments as they anticipate long delays and hold times followed by a long session of questions usually with a low rate of resolution. Therefore many customers prefer other modes of communication in order to avoid this frustration.

Thus we note that prior art methods have inherent limitations and are in need of improvement.

### SUMMARY OF THE INVENTION

Broadly speaking, the present invention provides a method and a system for self-care wherein unresolved device issues (e.g. from self-care) can be routed to appropriate customer care resources taking into account device specifics, customer preferences, and resource appropriateness.

In one embodiment, the customer launches the self-care app on the device. The app gathers the device information and also takes into account other information such as previous problems and their history, previous calls to the customer care department, text added by customer e.g. asking a specific question about a specific problem, etc. This gathered information is analyzed using a rules engine and if no resolution is found, a case is created that captures information about the device, additional information e.g. a customer asking a question: “Bluetooth not working”, and customer preferences. The information captured in the case is used for mapping a customer care agent best suited to tackle this issue and then the customer session is routed to the appropriate customer care resource using a channel of communication that is preferred by the customer.

According to one aspect, a method of self-care is provided such that an unresolved customer care issue is routed to the appropriate customer care resource(s) that specialize in solving the issues identified as a result of the execution of the rules engine. The appropriateness of the customer care resource may further be narrowed down by also taking into account the device type (e.g. make, model, version), preferred language of the customer, their time zone, preferred channel of communication, urgency of the issue amongst other items and mapping these with the customer care resource expertise, availability, language, time zone, communication channel use, etc.

Exemplary channels of communication that may be employed for communications between a customer and the customer care agent may include but are not limited to a voice call e.g. a phone call, e-mail exchange, a chat session, message boards, forums, etc.

Devices that can benefit from the system may include but are not limited to a computer, a server, network appliance, set-top box, SmartTV, embedded device, computer expansion module, personal computer, laptop, tablet computer, personal data assistant, game device, e-reader, a mobile device for example a Smartphone, any appliances having internet or wireless connectivity and onboard automotive devices such as navigational and entertainment systems. Such devices may also benefit from the fact that there are hundreds of parameters and by machine reading these data elements increased accuracy is ensured.

The system and the method provide a codified knowledgebase where rules are used to diagnose a problem and provide a fix or guidance to fix various types of devices. One such rules-based system is described and taught in U.S. patent application Ser. No. 13/968,631, filed Aug. 16, 2013, which is incorporated herein by reference. According to one aspect, a method of self-care is provided to a device whereby a sub-set of rules may be cached to the device and an agent or an app on the device executes these local rules. This enables a device to preferably run self-diagnosis without requiring any network connection and possibly incurring any data download fees. The system and method also reduce the need for computing power and bandwidth requirements on the server side, as millions of devices when encountering a common issue can cause a huge amount of traffic trying to connect to the server for a remedy. One such method and system of device-based self-care is described and taught in U.S. patent application Ser. No. 14/256,640, filed Apr. 18, 2014, which is incorporated herein by reference.

The appropriateness of the customer care resource is calculated by mapping the device information, urgency of the issue and customer preferences to customer care resource expertise, language proficiency, time zone and availability. In another embodiment the customer session may be routed to a voice call, while in another it may be routed to a chat session, dictated by customer preferences.

According to a first aspect of the invention, a computer-implemented method is provided for providing customer care to a user of an electronic device. A device profile of the electronic device is received. The profile has a plurality of parameters. Any text added by the user in a query is also received. These are used to create a customer care case. The customer care case is automatically routed to an appropriate resource or customer care agent channel based on an analysis carried out by computer of the parameters of the device profile and the added text.

In one embodiment, the text was added by the user in a self-care query. The customer care case may also include any prior self-care history with respect to the device. For example, a report may be received of any fixes attempted or guides or tutorials reviewed on the device in a self-care session. The customer care case may also include any prior customer care agent intervention history with respect to the device, and/or previous device profiles taken with respect to the device (and the system may note the delta between parameters from the prior device profile to the current one).

For example, the parameters may include the make and model of the device. The parameters may also include at least one service or service provider relevant to the device.

In certain embodiments, the receiving step occurs in response to a user or device request. The receiving step may occur during (or after) a self-care session (or after a predetermined period of time after the start of a self-care session). The receiving step may occur, for example, if a self-care session is reported to be or detected to be unsuccessful.

The analysis preferably further takes into account at least one customer preference. For example, the at least one customer preference may be selected from the list consisting of: communication channel, language, time zone, paid or free, sense of urgency (or severity), preferred prior customer care agent or department.

Preferably, the analysis automatically matches the customer care case to a customer care agent having particular expertise in devices having at least some of the parameters received in the device profile, and any problems or issues that may be interpreted from the added text. For example, the added text may be interpreted using natural language processing, or the user may have selected certain topics from menus, lists or icons.

In one embodiment, the analysis is used to route the customer care case to a customer care agent channel of qualified customer care agents. The customer care case is then made available for handling by one of the customer care agents in that customer care agent channel (e.g. the qualified agents in that channel may select from a queue of open cases).

According to a second aspect of the invention, a computer-implemented method is provided for providing customer care to a user of an electronic device. A database of expertise and availability parameters is maintained for a plurality of customer care agents. A customer care case is pre-screened to match at least one of the customer care agents in the database based on compatibility between the customer care case and the expertise and availability parameters of customer care agents in the database. The customer care case includes a device profile of the electronic device, and text added by the user in a query. The customer care case is made available for handling by the at least one customer care agent matched from the database.

In certain embodiments, customer care agents may be allowed to specify or modify preferences for customer care cases related to certain device parameters, or having certain problems or issues. Alternatively, or in addition, expertise may be automatically updated as customer care cases are handled.

The availability of customer care agents may be automatically detected (e.g. by certain agents being “on call” or signed on to the system or online at a given time). Alternatively, or in addition, customer care agents may be allowed to specify or modify availability parameters. The availability parameters may also include customer care agent language, time zone, or communication channel preferences. In addition, customer care channels (or agent groupings) or availability may be governed according to certain commercial or account-based parameters (e.g. fast track for customer loyalty programs, or higher grade of service package subscribed to).

### BRIEF DESCRIPTION OF THE FIGURES

FIG. 1 is a flow diagram illustrating routing to customer care following a self-care session according to an aspect of the present invention.

FIG. 2 is a flow diagram showing further detail with respect to device information and additional information gathering and processing.

FIG. 3 is a flow diagram showing the process for creating a customer care case following an attempted rules-based resolution.

FIG. 4 is a flow diagram showing the process for creating a customer care case following an attempted resolution through tutorial or guide-based self-care.

FIG. 5 is a flow diagram of a process after a customer care case is sent to a server for processing and routing.

FIG. 6 is a flow diagram of selectively matching a customer care agent to a customer care case.

### DETAILED DESCRIPTION

Before embodiments are explained in detail, it is to be understood that the invention is not limited in its application to the details of the examples set forth in the following descriptions or illustrated drawings. The invention is capable of other embodiments and of being practiced or carried out for a variety of applications and in various ways. Also, it is to be understood that the phraseology and terminology used herein is for the purpose of description and should not be regarded as limiting.

Before embodiments of the software modules or flow charts are described in detail, it should be noted that the invention is not limited to any particular software language described or implied in the figures and that a variety of alternative software languages may be used for implementation.

It should also be understood that many components and items are illustrated and described as if they were hardware elements. However, in at least one embodiment, the components comprised in the method and tool are actually implemented in software.

The present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. Computer code may also be written in dynamic programming languages that describe a class of high-level programming languages that execute at runtime many common behaviours that other programming languages might perform during compilation. JavaScript, PHP, Perl, Python and Ruby are examples of dynamic languages.

The embodiments of the systems and methods described herein may be implemented in hardware or software, or a combination of both. However, preferably, these embodiments are implemented in computer programs executing on programmable computers each comprising at least one processor, a data storage system (including volatile and non-volatile memory and/or storage elements), and at least one communication interface. A computing device may include a memory for storing a control program and data, and a processor (CPU) for executing the control program and for managing the data, which includes user data resident in the memory and includes buffered content. The computing device may be coupled to a video display such as a television, monitor, or other type of visual display while other devices may have it incorporated in them (iPad, iPhone etc.). An application or an app or other simulation may be stored on a storage media such as a DVD, a CD, flash memory, USB memory or other type of memory media or it may be downloaded from the internet. The storage media can be coupled with the computing device where it is read and program instructions stored on the storage media are executed and a user interface is presented to a user. For example and without limitation, the programmable computer may be a server, network appliance, set-top box, SmartTV, embedded device, computer expansion module, personal computer, laptop, tablet computer, personal data assistant, game device, e-reader, or mobile device for example a Smartphone. Other devices include appliances having internet or wireless connectivity and onboard automotive devices such as navigational and entertainment systems.

The program code may execute entirely on a mobile device or partly on the mobile device as a stand-alone software package; partly on the mobile device and partly on a remote computer or entirely on the remote computer or server. In the latter scenario, the remote computer may be connected to the mobile device through any type of network, including a local area network (LAN) or a wide area network (WAN), or the connection may be made to the internet through a mobile operator network (e.g. a cellular network). The code is specialized to execute functions described herein which enable a smoother and more efficient technological process.

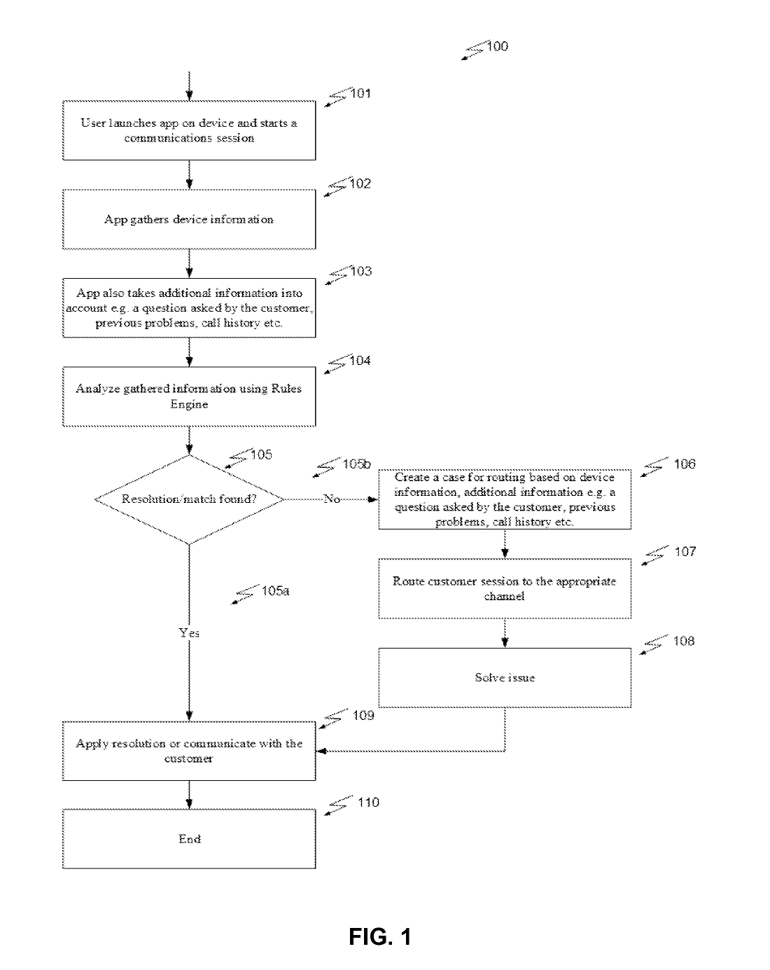

FIG. 1 is a flow diagram of certain overarching concepts of the present method. According to the method, the customer launches an app on the device and starts a communications session for self-care 101. Customers no longer want to call service providers to make changes to their services or to get some basic problem resolved. App and web based self-care systems are able to deliver a more convenient, always-on communication channel, that helps lower cost of customer service and reducing staff workload, by eliminating the number of customer service calls. Self-care enables customers to check their balances, view financial transactions and invoices, modify personal details, change billing cycle dates, modify payment methods, change service parameters, and fix some of the basic issues that they may encounter. In one embodiment the system and the method provides a self-care system that enables utilization of the computing power of a device, eliminating the need to connect to a remote server to fix a problem, thus reducing the computing power and bandwidth needed at the server side, eliminating the data costs on the device side and reducing expense and increasing the overall efficiency of the system.

In another embodiment the rules engine may be hosted on a remote server and the device may connect to the remote server over a network e.g. over internet.

The app gathers device information 102. Information that can be gathered from the device may include but is not limited to: the device make, model and manufacture information; applications (commonly referred to as “apps”) installed on the device; apps and processing running on the device; certificates on the device; user profile information; the character of any passcode used to authenticate a user (e.g. whether a password/passcode is used and the relative strength of that password, such as the number of characters); operating system of the device; information regarding whether the device operating system has been tampered with by the user (e.g. an iOS device has been jailbroken, or a Google Android device has been rooted); and the data usage e.g. the amount of MB or GB used for a given billing period, the amount data used while roaming, or the relative amount compared to a data plan used by the user—which may be useful for monitoring or controlling costs when paying for data usage.

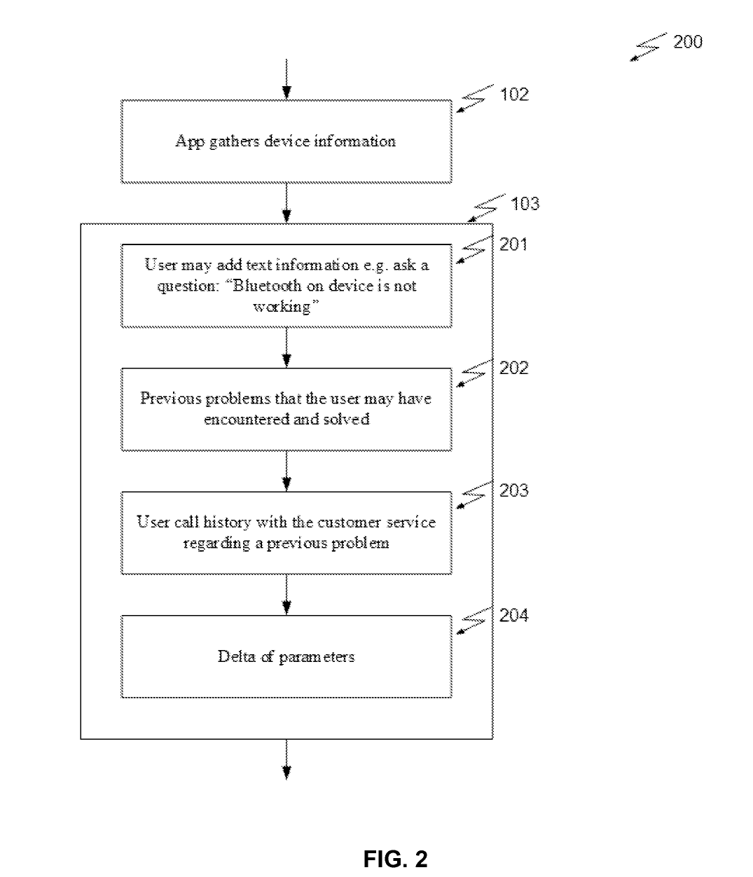

The app also takes additional information into account e.g. previous problems encountered, text added by the customer, call history etc. 103. More details on the additional information that may be taken into account are provided in FIG. 2.

This gathered information is then analysed using a rules engine 104. A rules engine is a software system that executes one or more rules in a runtime environment. A rules engine may be viewed as a sophisticated if/then statement interpreter. The if/then statements that are interpreted are called rules. In one embodiment the app may have the agent and the rules engine embedded in it while also providing a user interface using which a user may be able to add text e.g. ask a question. In another embodiment the rules engine and the rules may be on a remote server.

A rule consists of some number of conditions and some number of actions. Generally the rules are written in a high-level business language that relates to the domain, storing the rules in the repository. The Rules Repository may also include proto-rules i.e. rules not completely validated yet for implementation. A database may be used as the preferred and exemplary embodiment to store the rules. In another embodiment the rules may be stored in a list, in a table or other method that may be suitable for so doing.

A rule can generally be represented as IF CONDITION(S) THEN RECOMMENDATION(S)/FIX(ES). It can consist of one or more conditions (the “IF”). One or more conditions can be grouped together by “and” and “or” and the order of operations can be further defined using brackets. In each condition, there could be a device attribute, a conditional operator (=, >, <, !=, exists, not exists) and then a text box in which to enter static text, numeric, date-time value or another device attribute. These conditions can then be rearranged, grouped, and joined together to form a bigger condition.

A rule should also contain a recommendation or a fix (the “THEN”). When saved, the rules will follow the Rules Lifecycle (status including but not limited to DRAFT, PENDING, VALIDATION, REJECTED, VALIDATED (Nth), ACTIVE, INACTIVE) and only active rules may be disseminated to other sources. The scope of a rule can be system-wide, device-specific, model-specific, manufacturer-specific, operator-specific etc.

The system checks if a resolution or a match has been found by the rules engine 105. If a resolution or a match is found 105a, the resolution is applied or the fix is communicated with the customer 109. In one embodiment the fix is automatically applied. In another embodiment a solution is provided where the user may be able to edit, add, delete, and modify etc. the values required in a field. Following these solutions, the self-care process is ended 110.

If a resolution is not found 105b, then the system creates a case for routing to customer care 106. When creating a case all information is included that has been gathered from the device in steps 102 and 103 as well as the results of the rules engine execution from step 104. The customer session is routed to the appropriate channel 107.

As a result, the issue may be solved 108 and a resolution may be applied or a fix may be communicated with the customer 109, and the process ended 110.

FIG. 2 shows the information that can be gathered by the app from the device 200. In one embodiment, the app gathers device information 102. Information that can be gathered from the device may include but is not limited to: the device make, model and manufacture information; applications (commonly referred to as “apps”) installed on the device; apps and processing running on the device; certificates on the device; user profile information; the character of any passcode used to authenticate a user (e.g. whether a password/passcode is used and the relative strength of that password, such as the number of characters); operating system of the device; information regarding whether the device operating system has been tampered with by the user (e.g. an iOS device has been jailbroken, or a Google Android device has been rooted); and the data usage e.g. the amount of MB or GB used for a given billing period, the amount data used while roaming, or the relative amount compared to a data plan used by the user—which may be useful for monitoring or controlling costs when paying for data usage.

The user may also add text information 201. For example, the user may ask a question: “Bluetooth on device is not working”. Note that this added text (or other input, e.g. selection from a list or menu, selection of an icon) may have been entered in connection with the self-care session or before (e.g. prior web searches, chat or text sessions, etc.).

The app also gathers previous problems that the user may have encountered and solved 202. For example, the app may look into or seek further input as to what kind of problems the user encountered in the past with the same device and what was the success rate of solving these problems, who was the previous customer care agent and what is the customer's opinion/preference for using the same person. For example in one scenario a customer may opt to use the same customer care agent to solve a new issue as they may have had a good experience in the past when solving a previous issue. While in another scenario a customer may opt to use another customer care agent to solve the new issue as they may not be satisfied with the previous experience.

The app may also gather user call history with any previous customer service agents regarding previous problems 203. In one embodiment chat or e-mail trails or histories may also be taken into account.

The app may further gather the delta of parameters for the device 204. In one embodiment each rule may embody the actual, required values for the different fields e.g. SMTP Server, Gateway IP addresses, APN, Build Versions, User name, Passwords, list of malicious apps, etc. The actual values may be seeded in a rule or could be obtained from another source either on the server or on the device. In one embodiment the execution of the rules allows for the comparison of the values found on the device with the values in the rules. If the values are the same, i.e. the value of a field in the device and the value of the field in the rule are equal it is concluded that the rule has passed and that no fix may be required. If the two values i.e. the value of a field in the device and the value of the field in the rule are NOT equal it is concluded that the device is in need of a fix and the value of the field in the device may be replaced with the value of field in the rule.

In one embodiment a rule may embody a condition and may use some of the information that has been used to personalize the rule as well as the information gathered from the device. The rules may also preferably use reference values, standard values, target values, a range of values etc. to compare and create a list of delta of the values of a field on the device.

In one embodiment (as explained above) the value of a field from a rule may be used to update or correct the value of a field in the device. Alternatively, the system may provide a solution where the user may be able to edit, add, delete, and modify etc. the values required in a field. In another embodiment, the system may present information e.g. a notification or a tutorial or a roaming FAQ; alternatively it may suggest a remedy to the user as a course of action. In another embodiment the performance of the device may be fine tuned for better utilization of existing computing power and services being consumed.

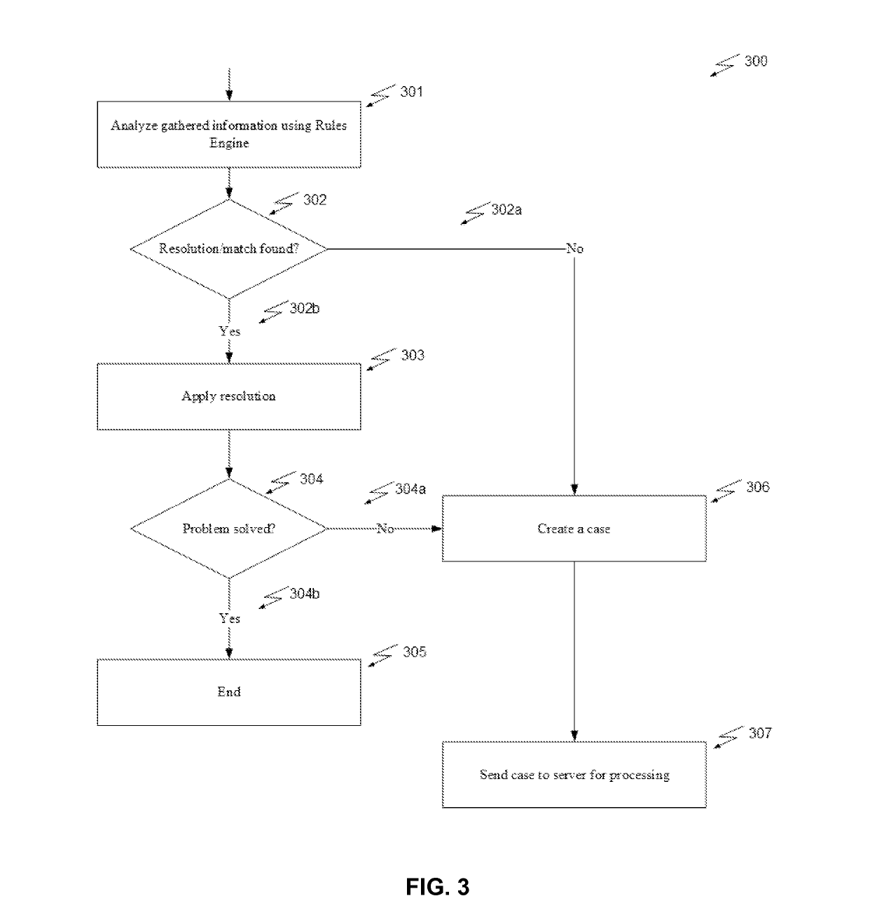

FIG. 3 shows the process 300 for creating a case before it is sent to the customer care department (or a customer care channel) for handling.

The system analyses the gathered information from the device using rules engine 301. The rules engine may be local to the device or may be remote. The system checks if a resolution or a match has been found 302. If Yes 302b, a match/resolution to the problem has been found, the system applies the resolution 303.

In one embodiment, the fix is automatically applied. In another embodiment, a solution is provided where the user may be able to edit, add, delete, and modify etc. the values required in a field.

The system checks if the problem is solved 304. If Yes 304b, the problem has been solved, then the process ends 305.

If No 302a, a match/resolution to the problem has not been found, then the system creates a case for the customer care department 306. Creating the case may include but is not limited to capturing the important information gathered from the device i.e. machine read data, delta of parameters, along with the information that the user may have added for example asked a specific question, previous problems that the customer may have faced, previous call history, customer preferences including whether the customer wants to use the same customer care agent or a different one etc.

Similarly if from step 304 it is determined that the problem has not been solved 304a, then the system creates a case 306 for the customer care department.

In one embodiment, if no resolution or remedy is available, the user may be prompted to escalate the issue. This process may be user initiated or may begin automatically depending on a number of factors including user preferences, settings etc. The case may be sent to the server for processing 307.

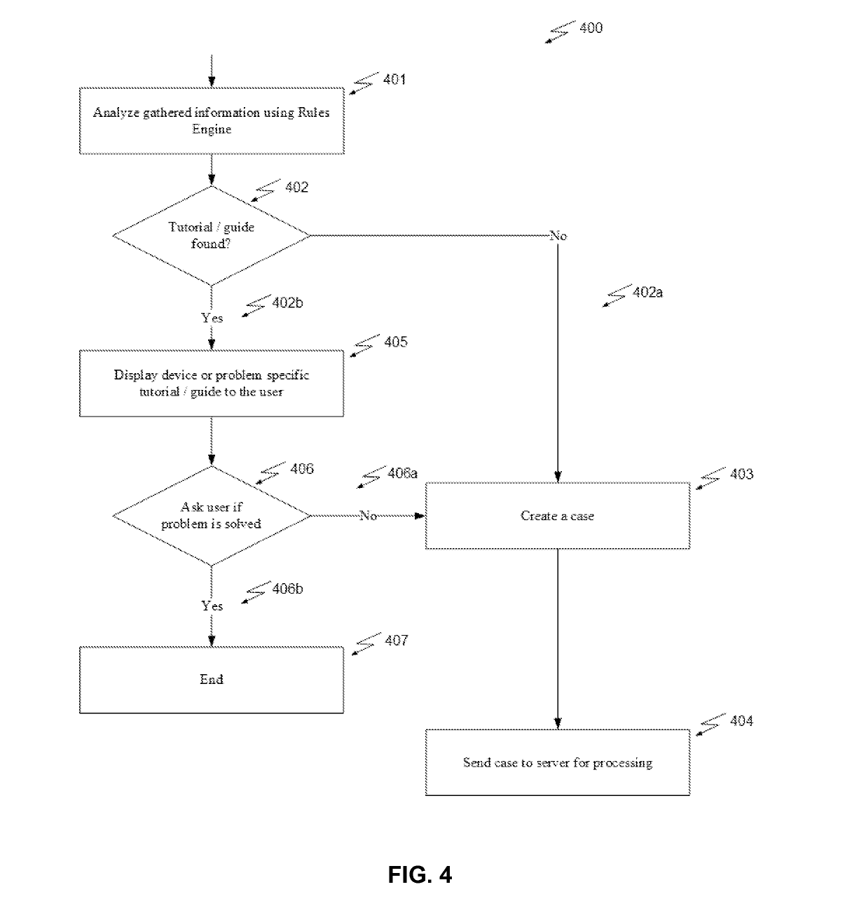

FIG. 4 shows another process 400 for creating a case before it is sent to the customer care department.

The gathered information is analysed from the device using rules engine 401. The rules engine may be local to the device or may be remote. The system checks if a tutorial or a guide has been found 402.

If No 402a, a tutorial or guide to the problem has not been found, then the system may create a case for the customer care department 403, and send the case to the server for processing 404.

If Yes 402b, a tutorial/guide to the problem has been found, the system may display the tutorial or guide to the user 405. In one embodiment, information is presented e.g. a notification or a tutorial or a roaming FAQ; alternatively, a remedy may be suggested to the user as a course of action. In another embodiment, the performance of the device may be fine tuned for better utilization of existing computing resources and services being consumed.

The system may ask the user if the problem is solved 406. If Yes 406b, the problem has been solved, the process ends 407.

If No 402a, a tutorial or guide to the problem has not been found, then the system creates a case for the customer care department 403. Similarly if from step 406 the customer reports that the problem has not been solved 406a (or the system detects that the problem has not been solved), then a case can be created 403 for the customer care department.

In one embodiment, if no resolution or remedy is available, the user may be prompted to escalate the issue. This process may be user initiated or may begin automatically depending on a number of factors including user preferences, settings etc. The system may send the case to the server for processing 404.

Note that although self-care examples are taught and described herein, the present method and system may also apply where no self-care was initially attempted but the user (customer) simply requests assistance from a customer care agent and the problem report is automatically routed. Further, such a request may be automatically triggered from some device event or malfunction (or as a planned follow-up from a previous customer care session).

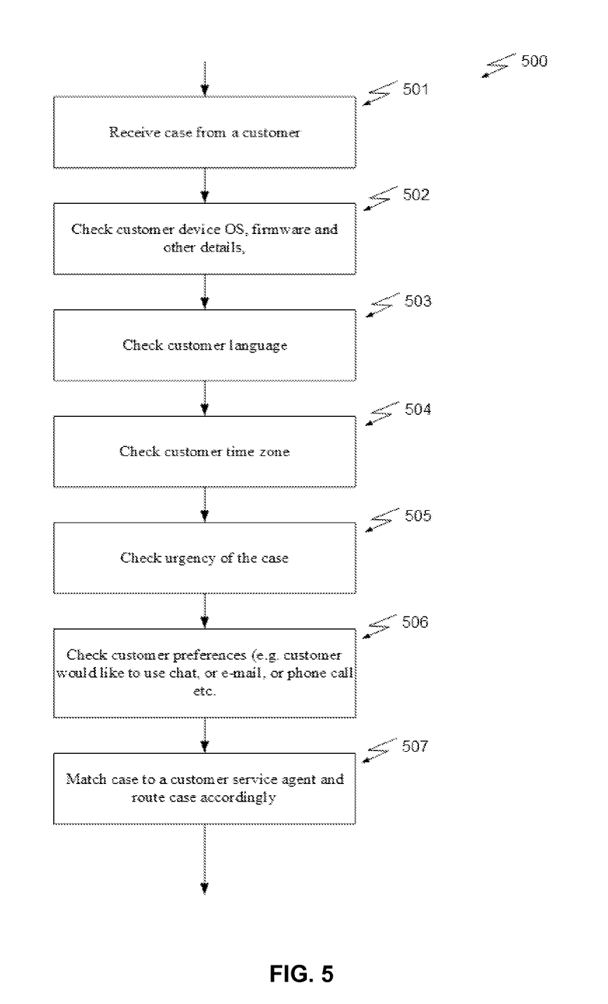

FIG. 5 shows the process after the case has been sent by the device and received at the server for further processing and routing 500.

At the server side, a case is received from a customer 501. The case when received may contain all the information that has been gathered at the device regarding the device itself as well as the additional information that may be relevant to the user, user preferences and previous problems that may have been encountered. Some or all of the additional information about customer preferences and a customer profile may be stored at the server and taken into account along with the information that has been gathered from the device.

The system preferably checks customer device OS, firmware and other details 502. Depending on the customer device OS, firmware and versions etc. the customer session will be routed to a customer care agent who specializes in that particular OS or firmware.

Customer language 503 or the language preferred by the customer for communications may also be checked. Depending on the customer's language of preference the customer session will be routed to a customer care agent who is fluent in that language.

Customer time zone 504 may also be checked. For example if the customer is in Eastern Time Zone and the current time is within the business hours, then the customer care session can be routed to the customer care agent in the same time zone. In another example if the customer is in Pacific Time Zone and the current time is outside of the business hours, the customer care session can be routed to a customer care agent in another time zone where it is still normal business hours.

Urgency or priority of the case may be checked 505. If the case is urgent or high priority then the case may be routed out of sequence to a customer care agent who may be available immediately.

Customer preferences for further contact may also be checked (e.g. customer would like to use chat, or e-mail, or phone call etc.) 506. Depending on the customer's preferences, the customer session will be routed to a customer care agent who will be adept at using the preferred mode of communications (or who shares the same preferred mode of communications).

The case can then be matched to a customer care agent and routed accordingly 507 taking into account all of the information that has been gathered from the device, the device OS, preferred language of the customer, customer time zone, customer preferences so that the case is placed with a customer care agent that fits all (or at least some) of this criteria. Channels of communications may include but are not limited to phone, e-mail, chat, message boards, forums, etc.

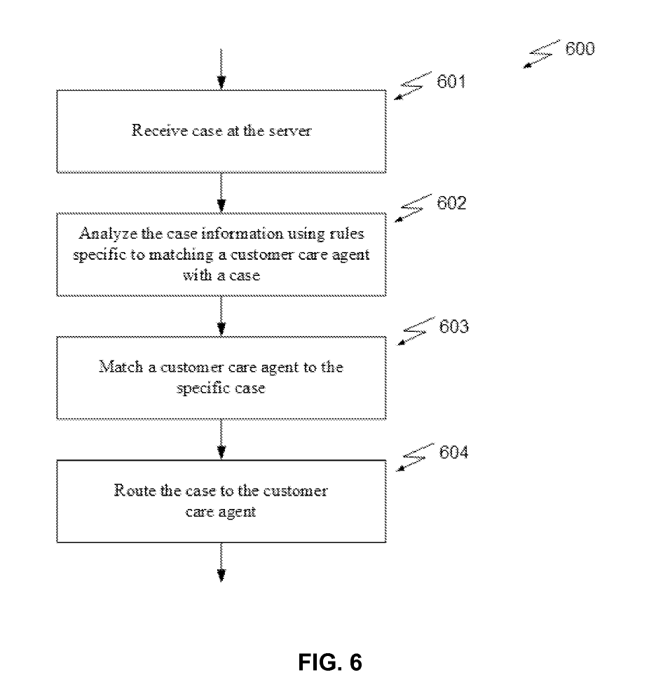

FIG. 6 shows the process for matching a customer care agent to a case. In one embodiment a case is received at the server 601.

The case information is analysed using rules specific to matching a customer care agent with a case 602. For example there may be a database that lists all the customer care agents, their availability, and their skills in terms of solving specific problems with specific devices, their language skills, preferred medium of communications, case load i.e. how busy a customer care agent is etc.

For clarity, this is a separate set of rules that is specific to matching a customer care agent to a case, not the rules used for evaluating the device profile and suggesting fixes/resolutions. The customer care agent matching rules are used to match a customer care agent to a case 603. For example these rules take into account the information that has been machine read from the device along with the information that the user may have provided for example asked a specific question, user preferences in terms of language, time zone, medium of communications etc. and finds the best fit in terms of a customer care agent who may be available in the same time zone as the customer, speaks the language that the customer prefers, has skills in tackling and solving the specific problem that the customer is facing, on the specific device make and model that the customer has etc. The case is routed based on these rules to the customer care agent 604. In one embodiment when a match between a customer care agent and the case is found, the case is routed to the customer care agent.

It is to be understood that the rules engine is not necessarily linear when executing the rules. There may be a common starting point when executing the rules, but as the rules get executed and as information gathered from the device and additional information is analyzed, one rule may trigger another rule that may be part of another set of rules. There may also be loops, so that there are rules embedded within rules, or a rule many call another rule as part of its execution. The rule that is called from within the loop or the rule that is called as part of the execution of another rule may not be fixed or static but may depend on the situation and vary as needed.

It should be understood that although the term application has been used as an example in this disclosure but in essence the term may also imply to any other piece of software code where the embodiments are incorporated. The software application can be implemented in a standalone configuration or in combination with other software programs and is not limited to any particular operating system or programming paradigm described here.

Several exemplary embodiments/implementations have been included in this disclosure, but the intent is to cover all such areas that may benefit from the present system and method.

The above examples are not intended to be limiting, but are illustrative and exemplary.

The examples noted here are for illustrative purposes only and may be extended to other implementation embodiments. While several embodiments are described, there is no intent to limit the disclosure to the embodiment(s) disclosed herein. On the contrary, the intent is to cover all practical alternatives, modifications, and equivalents.

What is claimed is:

1. A computer-implemented method of providing customer care to a user of an electronic device, comprising:
receiving a device profile of the electronic device, the profile having a plurality of parameters;
receiving text added by the user in a query;
creating a customer care case with the received parameters of the device profile and the added text from the user; and
automatically routing the customer care case to an appropriate resource or customer care agent channel based on an analysis carried out by computer of the parameters of the device profile and the added text.

2. The method of claim 1, wherein the text was added by the user in a self-care query.

3. The method of claim 1, further comprising receiving a report of any fixes attempted or guides or tutorials reviewed on the device in a self-care session.

4. The method of claim 1, wherein the customer care case further includes any prior self-care history with respect to the device.

5. The method of claim 1, wherein the customer care case further includes any prior customer care agent intervention history with respect to the device.

6. The method of claim 1, wherein the customer care case further includes prior device profiles taken with respect to the device.

7. The method of claim 1, wherein the parameters include the make and model of the device.

8. The method of claim 1, wherein the parameters include at least one service or service provider relevant to the device.

9. The method of claim 1, wherein the receiving step occurs in response to a user or device request.

10. The method of claim 1, wherein the receiving step occurs during a self-care session.

11. The method of claim 10, wherein the receiving step occurs after a predetermined period of time during the self-care session.

12. The method of claim 1, wherein the receiving step occurs if a self-care session is reported to be or detected to be unsuccessful.

13. The method of claim 1, wherein the analysis further takes into account at least one customer preference.

14. The method of claim 13, wherein the at least one customer preference is selected from the list consisting of: communication channel, language, time zone, paid or free, sense of urgency.

15. The method of claim 1, wherein the analysis automatically matches the customer care case to a customer care agent having particular expertise in devices having at least some of the parameters received in the device profile, and any problems or issues that may be interpreted from the added text.

16. The method of claim 15, wherein the added text is interpreted using natural language processing.

17. The method of claim 1, wherein the analysis routes the customer care case to a customer care agent channel of qualified customer care agents and makes the customer care case available for handling by one of the customer care agents in that customer care agent channel.

18. A computer-implemented method of providing customer care to a user of an electronic device, comprising:
maintaining a database of expertise and availability parameters for a plurality of customer care agents;
pre-screening a customer care case to match at least one of the customer care agents in the database based on compatibility between the customer care case and the expertise and availability parameters of customer care agents in the database, wherein the customer care case includes a device profile of the electronic device, and text added by the user in a query; and
making the customer care case available for handling by the at least one customer care agent matched from the database.

19. The method of claim 18, wherein the expertise is automatically updated as customer care cases are handled.

20. The method of claim 18, wherein availability of customer care agents is automatically detected.

21. The method of claim 18, further comprising allowing customer care agents to specify preferences for customer care cases related to certain device parameters, or having certain problems or issues.

22. The method of claim 18, further comprising allowing customer care agents to specify or modify availability parameters.

23. The method of claim 22, wherein the availability parameters include customer care agent language, time zone, or communication channel preferences.
